(19) United States
(12) Patent Application Publication
(10) Pub. No.: US 2019/0170137 A1
(43) Pub. Date: Jun. 6, 2019

(54) HEADER RING

(71) Applicant: GARDNER DENVER PETROLEUM PUMPS LLC, Tulsa, OK (US)

(72) Inventors: John Chase, Deer Park, TX (US); Troy E. Wiegand, Fort Worth, TX (US)

(21) Appl. No.: 15/951,757

(22) Filed: Apr. 12, 2018

Related U.S. Application Data
(63) Continuation of application No. 62/593,672, filed on Dec. 1, 2017.

(51) Int. Cl. F04B 53/02; F16J 15/22; F16J 15/18

(52) U.S. Cl. CPC F04B 53/02; F16J 15/3292; F16J 15/183; F16J 15/22

(57) ABSTRACT

A reciprocating pump includes a casing defining a pumping chamber, a plunger configured to reciprocate in an axial direction within the pumping chamber along a plunger axis, and an annular header ring positioned between the plunger and the casing. The annular header ring is formed solely of a fabric-reinforced rubber.

### BACKGROUND

High pressure reciprocating pumps are often used to deliver high pressure fluids during earth drilling operations. A sealing arrangement is provided between a pump casing and a reciprocating plunger to reduce the likelihood of leakage and to protect the plunger from potential damage from any abrasive components that may be contained in the fluid being pumped.

The sealing arrangement can include a header ring, such as the header ring shown in U.S. Pat. No. 9,534,691. The header ring disclosed in some embodiments of the '691 Patent is described as an annular body portion which is primarily made of a homogeneous elastomeric material. Bonded to the homogeneous elastomeric portion of body is an annular layer of a fabric reinforced elastomer, the layer covering the surfaces of a pedestal, a sealing lip, a bead and portions of the forward and rearward portions of the body forming surface.

### SUMMARY

The invention provides, in a first embodiment, a reciprocating pump. The reciprocating pump includes a casing defining a pumping chamber, a plunger configured to reciprocate in an axial direction within the pumping chamber along a plunger axis, and an annular header ring positioned between the plunger and the casing. The annular header ring is formed solely of a fabric-reinforced rubber.

The invention provides, in another embodiment, an annular header ring defining a central axis. The annular header ring includes a first axial side, a second axial side opposite the first axial side, a first radial side extending between the first and second axial sides and defining an inside diameter of the annular header ring, and a second radial side extending between the first and second axial sides and defining an outside diameter of the annular header ring. The annular header ring is a body uniformly constructed entirely of a fabric-reinforced rubber.

The invention provides, in yet another embodiment, a method of forming an annular header ring. A rubber material is mixed with a fabric material to form a fabric-reinforced rubber having fabric fibers. The fabric-reinforced rubber is cut into sheets on a bias, turning the fabric fibers to an offset angle. The sheets of the fabric-reinforced rubber are joined, and the rejoined sheets are cut into ribbons. The ribbons are stacked or coiled into a preform. The preform is compressed in a mold chamber of a compression mold.

### BRIEF DESCRIPTION OF THE DRAWINGS

FIG. 1 is a perspective view of a reciprocating pump including a fluid end.

FIG. 2 is a section view of the reciprocating pump of FIG. 1.

FIG. 3 is an enlarged view of the packing arrangement.

FIG. 4 is an enlarged cross section of a header ring taken along a plane that is parallel to the plunger axis.

FIG. 5 is a perspective view of a fabric or cloth reinforced elastomeric material for producing the header ring of FIG. 4.

FIG. 6 is an enlarged view of an alternative packing arrangement.

FIG. 7 is an enlarged view of yet another packing arrangement.

FIG. 8 is a cross-sectional view of compression molding plates.

FIG. 9 is a cross-sectional view of a header ring formed by the compression molding plates.

FIG. 10 is a cross-sectional view of a header ring having a modified inner surface.

Before any embodiments of the disclosure are explained in detail, it is to be understood that the invention is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting.

### DETAILED DESCRIPTION

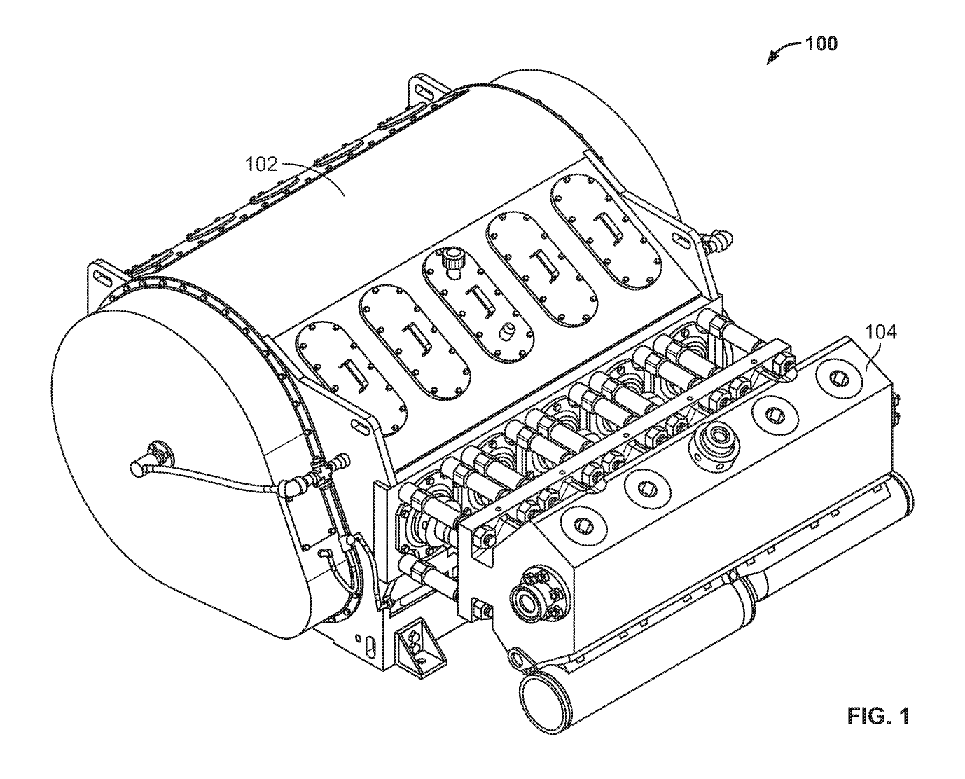

FIG. 1 illustrates a reciprocating pump 100 including a power end 102 and a fluid end 104. The power end 102 includes a crankshaft that drives a plurality of reciprocating plungers within the fluid end 104 to pump fluid at high pressure.

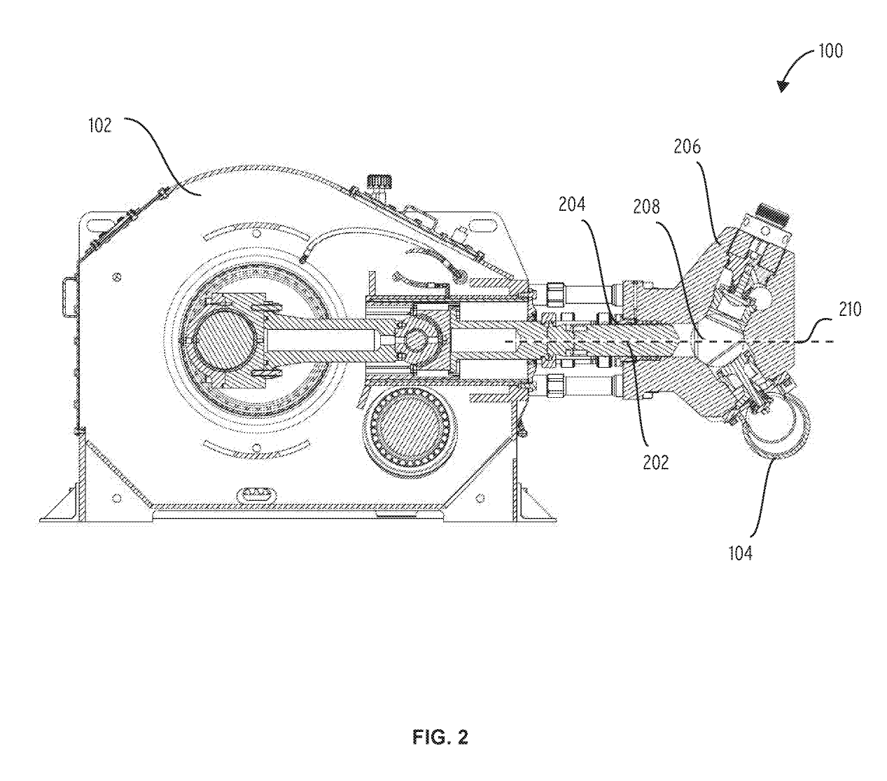

FIG. 2 is a section view taken through the central or plunger axis 210 of one of the plungers 202. Each of the pumping chambers 208 of the reciprocating pump 100 includes a plunger 202 that reciprocates within a casing 206 of the fluid end 104. With each stroke of the plunger 202, low pressure fluid is drawn into the pumping chamber 208 and high pressure fluid is discharged.

A packing arrangement 204 is positioned between the casing 206 and the plunger 202 to form a seal therebetween. The fluid within the pumping chamber 208 often contains abrasive material that can damage the packing arrangement 204 and the plunger 202 if not sealed properly.

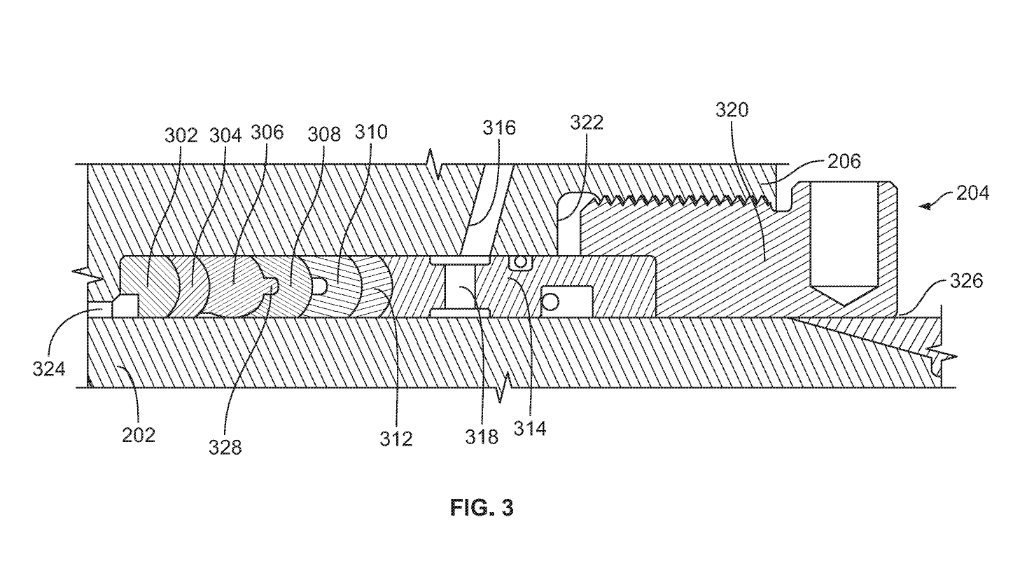

As illustrated in FIG. 3 the packing arrangement 204 is disposed within a packing box 322 that is formed as part of the casing 206 of the fluid end 104. The packing arrangement 204 includes a junk ring 302, a first support ring 304, a header ring 306, a first pressure ring 308, a second pressure ring 310, a second support ring 312, a lantern ring 314, and a packing nut 320.

Before discussing the packing arrangement 204 in detail it is important to understand the terms “upstream” and “downstream”. Any flow through the packing arrangement 204 or between the packing arrangement 204 and the plunger 202 flows from a high pressure side 324 of the packing box 322 to a low pressure side adjacent the packing nut 320. Thus, upstream would be in the direction away from the packing nut 320 while downstream would be in a direction toward the packing nut 320.

The junk ring 302 is positioned within the packing box 322 adjacent the high pressure end 324 and is preferably made of a hard material such as steel. The junk ring 302 is annular in shape with a cylindrical inside surface and a cylindrical outside surface. The junk ring 302 includes a planar lead surface that abuts a planar surface that defines the high pressure end 324 of the packing box 322. Opposite the planar surface is a male chevron portion that faces toward the low pressure end 326 of the packing box 322.

The first support ring 304 is annular in shape and includes a cylindrical inner surface that abuts the plunger 202 and a cylindrical outer surface that abuts the wall of the packing box 322. The first support ring 304 also includes a female chevron portion that faces the high pressure end 324 and abuts the male chevron portion of the junk ring. A male chevron portion is positioned opposite the female chevron portion and faces toward the low pressure end 326. In preferred constructions, the first support ring 304 is manufactured from a material such as polyether ether ketone (PEEK).

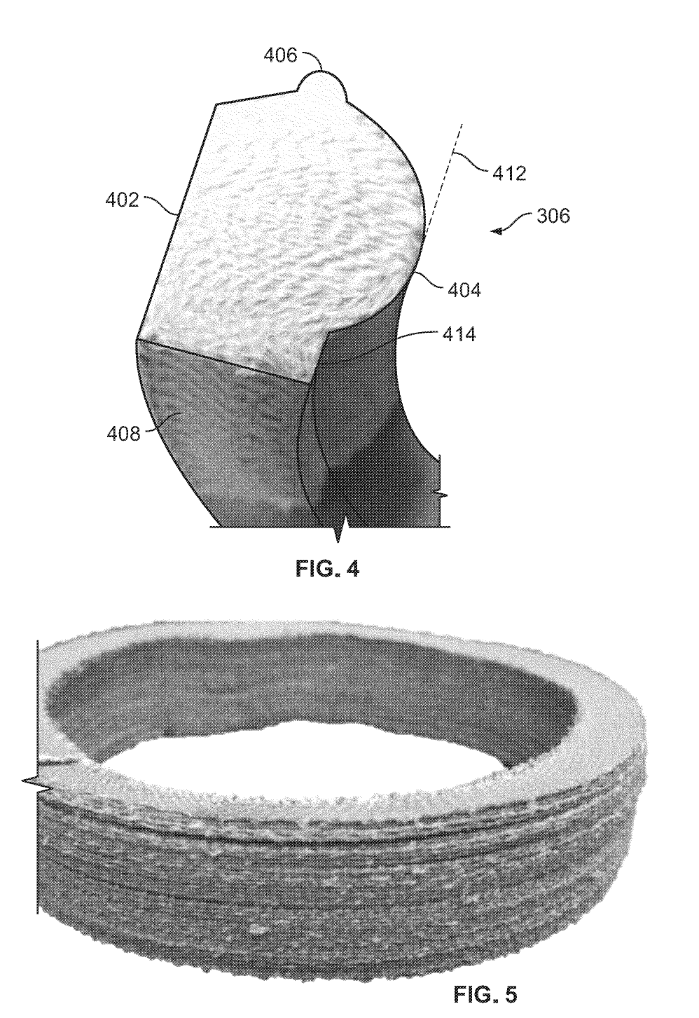

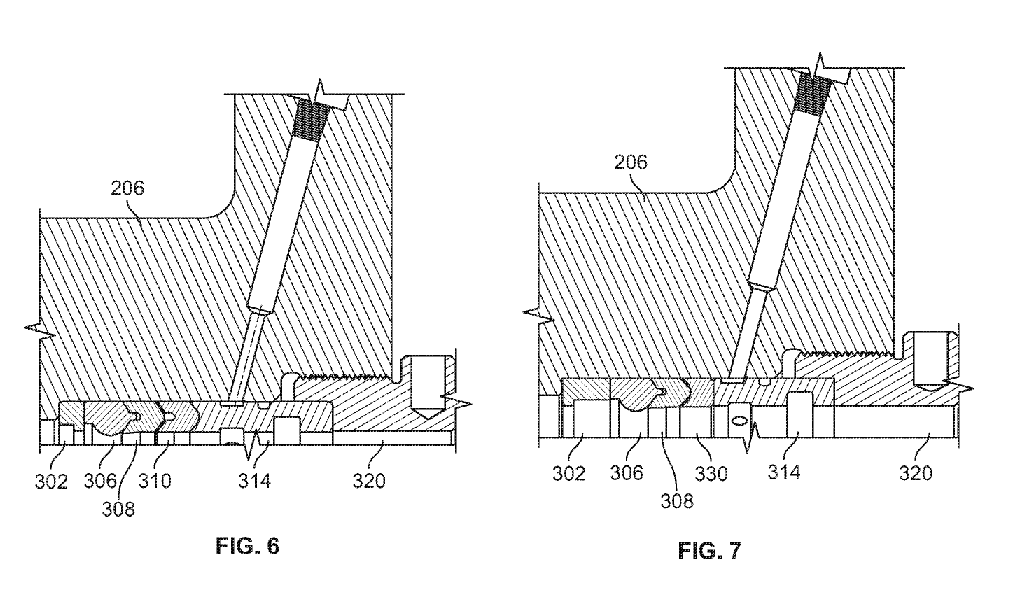

The header ring 306 is positioned on the low-pressure side of the first support ring 304 and on the high pressure side of the first pressure ring 308. Alternatively, the header ring 306 may be positioned between the first and second pressure rings 308, 310. The header ring will be discussed in greater detail with regard to FIG. 4. As a further alternative, as shown in FIGS. 6-7, the header ring may abut directly against the junk ring 302 or directly against the high pressure end of the packing box 322 (i.e., the high pressure end of the casing 206) without a junk ring 302 or first support ring 304 therebetween.

The first pressure ring 308 is an annular ring that includes a cylindrical inner surface that abuts the plunger 202 and a cylindrical outer surface that abuts the bore of the packing box 322. A high pressure side of the first pressure ring 308 includes a female chevron portion arranged to receive the male chevron portion of the header ring 306. An aperture 328 is formed in the female chevron portion and provides a relief should the arms of the female chevron portion be forced apart. A male chevron portion, opposite the female portion extends toward the low pressure end 326 of the packing box 322. In preferred constructions, the first pressure ring 308 is formed from an elastomer impregnated aramid fabric.

The second pressure ring 310 is identical to the first pressure ring 308 and the second support ring 312 is identical to the first support ring 304. The second support ring 312 is positioned on the low pressure side of the second pressure ring 310.

The first and second pressure rings 308, 310 are the primary sealing components of the packing arrangement, bearing the brunt of the pressure applied by the high-pressure fluid within the pumping chamber 208. Therefore, the pressure rings 308, 310 are stiff or inflexible and lack springiness (relative to the header ring 306).

The lantern ring 314 is an elongated annular ring that includes an inner cylindrical surface that abuts the plunger and an outer cylindrical surface that abuts the surface of the packing box 322. The high pressure side of the lantern ring 314 includes a female chevron portion that is arranged to receive the male chevron portion of the second support ring 312. One or more lube oil bores 318 pass between the inner surface and the outer surface and provide a flow path for lube oil that is delivered to the packing arrangement 204 via the lube oil passage 316. In preferred constructions, the lantern ring 314 is formed from a metal such as aluminum, bronze, or an aluminum-bronze alloy.

Lube oil can be provided to the packing arrangement 204 via the lube oil passage 316 and the lube oil bore 318. The lube oil creates a pressure seal that enhances the function of the packing arrangement 204 while provided lubrication between the plunger 202 and the packing arrangement 204.

The packing nut 320 threadably engages the casing 206 and is movable between a first position and a second position in which the packing nut 320 compresses the lantern ring 314 against the stack including the second support ring 312, the second pressure ring 310, the first pressure ring 308, the header ring 306, the first support ring 304, and the junk ring 302. Collectively, the components of the packing arrangement 204 are compressed in the direction of the piston axis by the packing nut 320, expanding radially to better contact the outer wall or bore of the packing box 322 and the outer surface of the plunger 202.

As illustrated in FIG. 4 the header ring 306 includes an annular outer surface 402 sized to abut the surface of the packing box 322. An inner surface 404 defines a minimum inside diameter 412 that is preferably smaller than the outside diameter of the plunger 202 to assure solid contact with the plunger 202 to improve the seal. A first portion of the inner surface 404 is non-cylindrical and is defined by the revolution of a curved line about the center line of the header ring 306. The inner surface 404 further includes a second portion—an annular step or cutout 414, adjacent a high pressure side 408 of the header ring 306. The cutout 414 may be adjacent to the first portion or may otherwise extend partially into the curved line defined by the first portion.

A low pressure side of the header ring 306 includes a male chevron portion and a knob portion 406 extending from the male chevron portion toward the low pressure end 326 of the packing box 322. The knob portion 406 is sized to be received in the aperture 328 of the first pressure ring 308 when the packing arrangement 204 is assembled.

The high pressure side 408 of the header ring 306 includes a surface portion that is shaped to mate with the adjacent surface. As shown in FIGS. 4, 6, and 7, the high pressure side 408 of the header ring 306 is relatively flat to mate with the high pressure end of the packing box 322 or the low pressure side of the junk ring 302. Alternatively, as shown in FIG. 3, the high pressure side of the header ring 306 may include a female chevron portion sized to engage the male chevron portion of the first support ring 304.

The header ring 306 has greater elasticity than the pressure rings 308, 310 to maintain a constant force on the pressure rings 308, 310 when assembled in the packing arrangement 204. Specifically, when the packing nut 320 is threaded to the casing 206, the nut 320 compresses the rings 306, 308, 310. The header ring 206 provides flexibility to compensate for minor compression fluctuations to maintain a constant axial force on the pressure rings 308, 310 for sealing.

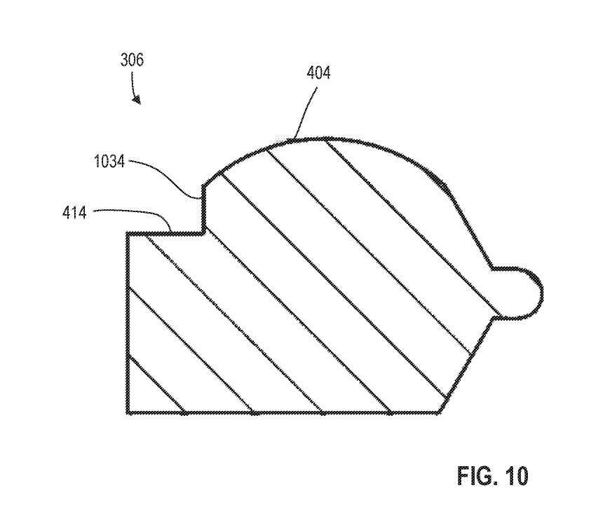

FIG. 10 illustrates a header ring 306 having a modified geometry. Specifically, the header ring includes a radial step or cutout 1034 between the inner surface 404 and the axial step 414. The step cutout formed by the radial and axial steps 1034, 414 may increase the flexibility of the inner surface 404 that contacts the plunger 202.

The header ring 306 is formed entirely of a cloth or fabric reinforced elastomeric material, such as a fabric reinforced rubber, and more specifically an aramid reinforced rubber. The annular outer surface 402, the inner surface 404, the low pressure side including the knob portion 406, and the high pressure side 408 of the header ring 306 are formed of the fabric reinforce rubber. Further, the area between the aforementioned surfaces 402, 404, 406, 408 is likewise made of the same fabric reinforced material. In other words, the header ring 306 is a body uniformly constructed entirely from the fabric reinforced elastomeric material without the presence of other dissimilar materials embedded within the body or forming outer layers of the body. Common trade names for aramid fabrics include Kevlar, Nomex, and Twaron.

To form the fabric reinforced rubber into the header ring 306, a rubber material (e.g., hydrogenated nitrile butadiene rubber) is mixed with a fabric. The rubber material may be calendered (i.e., via a calender machine using rollers to smooth and thin the material) with the fabric to specification (e.g., with a 35-75 percent rubber pickup, with a 55-65 percent rubber pickup). The roll of rubber-fabric is then cut into sheets on a bias to turn the fabric fibers to an offset angle. The bias cut sheets are joined back together, and cut into ribbon. That ribbon is then turned on edge and stacked or coiled into the preform, as shown in FIG. 5.

Alternatively, the reinforced rubber may be formed via a dip coating or solution coating process. In the dip coating process, the rubber material is dissolved in an applicable solvent for the particular rubber chemistry, or is otherwise converted into a liquid or low viscosity flowable state using an organisol or plasticol. The liquid rubber is then applied to the fabric. The fabric may be pulled through the liquid rubber, or alternatively, the liquid may be applied via a spray coat (e.g., using pneumatic spray equipment, airless sprayers, etc.). Further still, the liquid rubber may be applied via a transfer roll mechanism in which the liquid is applied to the roll and the roll contacts with the fabric to transfer the liquid to the fabric. With a transfer roll mechanism, the coat weight is controlled by varying the roll speed relative to the fabric speed. Once the fabric has been coated, it passes into an oven to remove the solvent or gel the rubber into the fabric, thereby producing the solid rubber-fabric composite. The rubber-fabric material is then rolled and cut as described above.

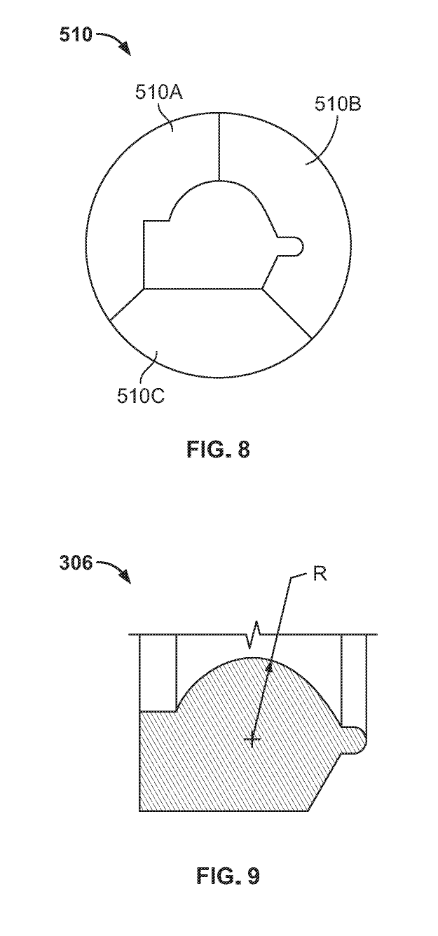

The preform is placed into a mold chamber of a compression mold, such as the mold 510 shown in FIG. 8. As shown, the compression mold includes three mold components 510A, 510B, 510C that collectively define the mold chamber. Pressure is applied to the mold components 510A, 510B, 510C such that the fabric reinforced rubber is forced into contact with all areas within the mold chamber. As shown in FIG. 9, the fabric reinforced rubber is molded to the finished shape, producing the header ring 306. Some flashing may be produced in the molding process, which can be removed via a post-processing step.

Other header rings may be formed of a homogeneous elastomeric material or may include a fabric-reinforced layer covering surfaces of a homogenous elastomeric material. Such header rings lack advantages of the header ring 306 discussed above. Specifically, a purely elastomeric header ring lacks the strength and wear resistance provided by the fabric reinforcement. Further, coating a homogeneous elastomeric material with a fabric-reinforced layer only provides limited advantages over the bare homogenous elastomeric material core. Specifically, the interface between the coating and the core provides an additional point of failure for the header ring. Further, as the plunger reciprocates against the header ring, the coating applied to the core can shear away from the core as the fibers of the coating that contact the reciprocating plunger are oriented substantially parallel to the axial direction defined by the movement of the plunger.

In contrast to the other header rings described above (i.e., the purely elastomeric header ring and the header ring having a fabric-reinforced coating), the header ring 306 is formed solely of the fabric-reinforced rubber, such that there is no interface within the header ring 306 that is parallel to the axial direction at or adjacent to the inner surface 404 (that contacts the plunger 202) of the header ring 306. Further the manufacturing processes utilized to form the header ring orient the fibers of the fabric-reinforced material perpendicular to the axial direction (i.e., the direction of travel of the plunger 202), thereby increasing the shear strength of the header ring 306 in the contact region of the inner surface 404.

Experimental testing has been conducted to compare the reliability of the fabric-reinforced rubber header ring 306 described above to an elastomeric header ring having a fabric-reinforced coating. Running at 9500 psi, the fabric-reinforced rubber header ring 306 experienced a failure rate of 2.5 percent after 144 stages. In comparison, the elastomeric header ring having a fabric-reinforced coating experienced a failure rate of 71.1 percent after the same number of stages. The fabric-reinforced rubber header ring 306 was tested to have an average life approximately five times greater than the average life of the elastomeric header ring having a fabric-reinforced coating. A second test was conducted at 10,200 psi with a 100 percent failure rate at 35 hours of the elastomeric header ring having a fabric-reinforced coating. The fabric-reinforced rubber header ring 306 had no failures when the test concluded at 138 hours. Increasing the average life of the header ring decreases downtime of the reciprocating pump 100 and likewise decreases maintenance work.

What is claimed is:

1. A reciprocating pump, comprising:
a casing defining a pumping chamber;
a plunger configured to reciprocate in an axial direction within the pumping chamber along a plunger axis; and
an annular header ring positioned between the plunger and the casing, the annular header ring formed solely of a fabric-reinforced rubber.

2. The reciprocating pump of claim 1, further comprising an annular pressure ring abutted against the annular header ring.

3. The reciprocating pump of claim 1, wherein the annular header ring is one of a plurality of annular components defining a packing arrangement, the plurality of annular components further comprising an annular pressure ring, a lantern ring, and a packing nut.

4. The reciprocating pump of claim 3, wherein the packing nut includes threads configured to threadably engage the casing and is configured to compresses the lantern ring against the annular pressure ring and the annular header ring.

5. The reciprocating pump of claim 1, wherein the annular header ring includes an inner surface defining a minimum inside diameter of the annular header ring, wherein at least a portion of the inner surface is non-cylindrical and is defined by the revolution of a curved line about the plunger axis.

6. The reciprocating pump of claim 5, wherein the minimum inside diameter of the annular header ring is less than an outside diameter of the plunger.

7. The reciprocating pump of claim 1, wherein the plunger is configured to reciprocate between a first position and a second position, wherein the annular header ring is deformed by the plunger in at least one of the first position or the second position.

8. The reciprocating pump of claim 1, wherein the annular header ring includes a plurality of fibers, wherein the plurality of fibers is oriented substantially perpendicular to the axial direction.

9. The reciprocating pump of claim 1, wherein the plunger is a first plunger of a plurality of plungers, the reciprocating pump further comprising a crankshaft that drives the plurality of plungers to pump fluid at high pressure.

10. An annular header ring defining a central axis, the annular header ring comprising:
a first axial side;
a second axial side opposite the first axial side;
a first radial side extending between the first and second axial sides and defining an inside diameter of the annular header ring; and
a second radial side extending between the first and second axial sides and defining an outside diameter of the annular header ring,
wherein the annular header ring is a body uniformly constructed entirely of a fabric-reinforced rubber.

11. The annular header ring of claim 10, wherein the fabric reinforced rubber comprises a plurality of fibers, and wherein the plurality of fibers are oriented to extend in a lengthwise direction between the first radial side and the second radial side.

12. The annular header ring of claim 10, wherein the header ring is constructed without the presence of other dissimilar materials embedded within the body or forming outer layers of the body.

13. The annular header ring of claim 10, wherein the fabric-reinforced material is formed of a hydrogenated nitrile butadiene rubber and an aramid fabric.

14. The annular header ring of claim 10, wherein at least a portion of the inner surface is non-cylindrical and is defined by the revolution of a curved line about the central axis

15. The annular header ring of claim 10, wherein the first axial side includes a male chevron portion and a knob portion extending from the male chevron portion, the knob portion defining a first axial extent of the annular header ring.

16. A method of forming an annular header ring, the method comprising:
mixing a rubber material with a fabric material to form a fabric-reinforced rubber having fabric fibers;
cutting the fabric-reinforced rubber into sheets on a bias, turning the fabric fibers to an offset angle;
joining the sheets of the fabric-reinforced rubber, and cutting the rejoined sheets into ribbons;
stacking or coiling the ribbons into a preform; and
compressing the preform in a mold chamber of a compression mold.

17. The method of claim 16, wherein the header ring is a body uniformly constructed entirely from the fabric reinforced rubber without the presence of other dissimilar materials embedded within the body or forming outer layers of the body.

18. The method of claim 16, wherein mixing the rubber material with the fabric material includes calendaring the rubber material with the fabric material.

19. The method of claim 16, wherein mixing the rubber material with the fabric material includes dissolving the rubber material in a solvent, applying the dissolved rubber material to the fabric material, and heating the dissolved rubber material and the fabric material, gelling the rubber into the fabric.

20. The method of claim 19, wherein applying the dissolved rubber material to the fabric material includes one of pulling the fabric material through the liquid rubber, applying a spray coat of the liquid rubber to the fabric material, or utilizing a transfer roll mechanism.
